(19) United States
(12) Patent Application Publication
(10) Pub. No.: US 2021/0120213 A1
(43) Pub. Date: Apr. 22, 2021

(54) WEARABLE REARVIEW CAPTURING DEVICE

(71) Applicant: Kamran Naderi Beni, Tehran (IR)

(72) Inventor: Kamran Naderi Beni, Tehran (IR)

(21) Appl. No.: 16/655,098

(22) Filed: Oct. 16, 2019

(51) Int. Cl. H04N 7/18; H04N 5/225; G02B 27/01

(52) U.S. Cl. CPC H04N 7/185; H04N 5/2253; G02B 27/0101; G02B 2027/014; G02B 2027/0138; G02B 2027/0178; G02B 27/0172

(57) ABSTRACT

A wearable rearview capturing device to display a field of view of the region behind a user without interfering the user's forward and peripheral vision, is disclosed. The device comprises a camera and a processor. The camera is configured to capture visual data of rearward field of view of the user. The processor in communication with the camera is configured to generate and display a mirror view of the visual data at a display device. The display device is in communication with the processor via at least one of a wired module or a wireless module. The visual data include video and/or images. The camera might be configured to record audio data along with the visual data. The visual data is displayed in at least a portion of the display device.

### BACKGROUND OF THE INVENTION

Mirrors or reflective device have been used to provide a rearview for driving, cycling, and other activities where turning the head to obtain a view is either unsafe or difficult due to circumstances. Often the individual needing the enhanced vision moves comparatively little, but is surrounded by a working environment with a number of dangerous moving objects or the individual simply needs to have a better perspective of their surroundings. Examples of these individuals include motorcyclists, safety flaggers, factory or plant employees, traffic police, bodyguards, soldiers, construction site workers, firefighters, forklift and other equipment operators, hunters, joggers, cyclists, other athletes, and the like.

However, reflective devices may only provide limited vision enhancement, while introducing cumbersome extensions that may actually present additional safety hazards to the individual. These extensions are often attached to a clothing article, such as a hat or other form of headgear and often prevent use of the clothing article for other activities. Additionally, some existing reflective devices actually extend into the path of traffic may be clipped or knocked by a passing vehicle and thereby knock anything attached to the device, which at best might knock off the hat or glasses, but at worst could potentially twist the head of the wearer. Moreover, they look weird and many are reluctant to use such devices. Another way to do this is holding a mirror in hand which cannot be done all the time, and it would look unusual.

In recent years, two different kinds of motorcycle helmets have been made to provide rearview for bikers. One type of helmet (made by a company named Skull Helmets) is equipped with a camera on its back and shows its images on a screen embedded in its windshield in front of the eyes of the user. Another type of helmet (made by Japanese motorcycle manufacturers) shows the obtained images on a screen that has been added to some models of its motorcycles beside their panel and gauges. Obviously, the above two offer the ability of looking backward to a group limited to motorcyclists and in particular, in the second example, the ones who use a specific model of motorcycle.

However, the existing system/devices are not suitable for the daily lives of ordinary people. The existing systems are obtrusive and bulky, may interfere with the forward vision of the individual, and have not been widely adopted and used. Therefore, there is a need for a device that is not bulky and provides a sufficient rearward field of view without interfering with the forward and peripheral vision of the individual.

### SUMMARY OF THE INVENTION

The present invention provides a wearable rearview capturing device. The device is configured to display a field of view of the region behind a wearer/user without interfering the forward and peripheral vision.

In one embodiment, the device comprises a camera and a processor. The camera is configured to capture visual data of the rearward field of view of the user. The processor in communication with the camera configured to generate and display a mirror view of the visual data at a display device. The visual data is at least one of video or image. In one embodiment, the camera is further configured to record audio data along with the visual data. The device further comprises a power source in communication with the camera and the processor.

In one embodiment, the visual data is projected directly onto the user's retina. In one embodiment, the display device is in communication with the processor via at least one of a wired module or a wireless module. In another embodiment, the display device is a see-through display screen. In yet another embodiment, the display device could be attached to the existing smart devices as an additional display, similar to prism in google glass. In yet another embodiment, the display device could be attached to the smart glass in addition to the lenses or display that are embedded in the frame of the smart glass. In yet another embodiment, the display device is at least one of a smartphone, a smartwatch, a tablet or an electronic device with a display. In yet another embodiment, the display device is a display screen embedded in at least one of a smart glass, a bionic lens, a contact lens, or a spectacle such as google glass. In yet another embodiment, the display device is a display screen embedded in a windshield of vehicle such as motorcycle, bike. In one embodiment, the device is attached to at least one of a rear end, a side end, a top end or a bottom end of an article. In one embodiment, the article is of at least one of a garment, a hat, a cap, a helmet, a bag, a handbag, a purse, a backpack, a decorative spectacle, a professional spectacle, a protective spectacle, a spectacle frame, a sunglass, a medical glass, a goggle, a ski goggle, a snowboard goggle or a spectacle of the wearer. The camera can be at least one of a colored camera, a black and white camera, a monochrome camera, a night vision camera, or an infrared camera.

In another embodiment, the device comprises a camera, a processor and a display device. The camera is to capture visual data of rearward field of view of the user. The processor in communication with the camera is configured to generate a mirror view of the visual data. The display device in communication with the processor is configured to display the generated visual data to the user. In one embodiment, the camera is detachably mounted at the head mounted display. In another embodiment, the camera is adjustably mounted at the head mounted display. In one embodiment, the head mounted display is a smart eyewear. In another embodiment, the head-mounted display is at least one of a virtual reality smart glass, a mixed reality smart glass, or an augmented reality smart glass. In yet another embodiment, the head-mounted display includes any type of smart glass with any other possible function that may be developed and introduced in the future. In yet another embodiment, the head-mounted display is a smartphone in the shape of smart glass. In another embodiment, the head-mounted display is a smart frame without lenses but with a screen to display.

In yet another embodiment, the device comprises a head mounted display comprising a processor module, and a camera mounted to the head mounted display. The camera is to capture visual data of rearward field of view of the user. The processor module in communication with the camera is configured to generate and display a mirror view of the visual data at the head mounted display. The device further comprises a power source in communication with the head-mounted display, the processor module and the camera. In one embodiment, the power source is a battery. In another embodiment, the power source comprises solar panels to supply portable electrical power.

One aspect of the present disclosure is directed to a rear-view capturing device, comprising: a camera configured to capture visual data of rearward field of view of a user; and a processor in communication with the camera configured to generate and display a mirror view of the visual data at a display device, wherein the visual data is at least one of video or image, and wherein the camera is a wearable camera. In another embodiment, the camera is further configured to record audio data along with the visual data. The device further comprises a power source in communication with the head-mounted display, the processor module and the camera. In one embodiment, the power source is a battery. In another embodiment, the power source comprises solar panels to supply electrical power.

In one embodiment, the device further comprises a power source in communication with the camera and the processor. In another embodiment, the display device is in communication with the processor via at least one of a wired module or a wireless module like Bluetooth®. In one embodiment, the display device is a see-through display screen embedded in the lens(es) of a smart glass of any type. In another embodiment, the display device is a screen added to the smart glass in addition to the lenses on a frame of the smart glass. In yet another embodiment, the display device is a screen added to a smart frame, which could be worn solely or over any type of spectacles or glasses. In yet another embodiment, the display device is at least one of a smartphone, a smartwatch, a tablet or an electronic device with a display. In one embodiment, the display device is a display screen embedded in at least one of, smart glasses, bionic lens, contact lens, or spectacles. In one embodiment, the visual data is projected directly onto the user's retina by a laser beam. In another embodiment, the display device is a display screen embedded in a windshield of vehicle such as motorcycle, bike.

In another embodiment, the camera is mounted at a head mounted display comprising a processor module, wherein the processor module is configured to generate and display the mirror view of the visual data at the head mounted display. In one embodiment, the display device is mounted to the head mounted display, and wherein the processor module is configured to display the mirror view of the visual data at the display device. In another embodiment, the camera is detachably mounted at the head mounted display. In one embodiment, the camera is adjustably mounted at the head mounted display. In a related embodiment, the head mounted display is a smart eyewear. In one embodiment, the head-mounted display is at least one of a virtual reality smart glass, a mixed reality smart glass, or an augmented reality smart glass. In another embodiment, the head mounted display is a smart phone in the shape of smart glass. In another embodiment, the smart glass might have a function different from the a/m functionalities. In one embodiment, the head-mounted display is at least one of a smart eyewear, a virtual reality smart glass, a mixed reality smart glass, a smart phone in the shape of smart glass, a smart glass or an augmented reality smart glass.

In one embodiment, the camera is attached to at least one of rear end, a side end, a top end or a bottom end of an article worn by the user. In one embodiment, the article is of at least one of, decorative spectacles, professional spectacles, protective spectacles, spectacles frame, sunglass, medical glass, goggle, ski goggle, snowboard goggle or spectacles of the wearer. In another embodiment, the article is a garment. In one embodiment, the article is of at least one of garment, accessories, handbags, purses, hats, helmets, bags, luggage, carrying objects or backpacks. In one embodiment, the camera is at least one of a coloured camera, a black and white camera, a monochrome camera, a night vision camera, or an infrared camera. In one embodiment, the visual data is displayed in at least a portion of the display device.

Another aspect of the present disclosure is directed to a rear-view capturing device, comprising: a camera configured to capture visual data of rearward field of view of a user; a processor in communication with the camera configured to generate a mirror view of the visual data; and a display device in communication with the processor configured to display the generated visual data to the user, wherein the visual data is at least one of video or image. The device further comprises a power source in communication with the head-mounted display, the processor module and the camera. In one embodiment, the power source is a battery. In another embodiment, the power source comprises solar panels to supply electrical power. In one embodiment, the camera is a rear-view camera in communication with the processor via at least one of a wired module or a wireless module.

Another aspect of the present disclosure is directed to a rear-view capturing device, comprising: a head mounted display comprising a processor module; and a camera mounted to the head mounted display configured to capture visual data of rearward field of view of a user, wherein the processor module in communication with the camera is configured to generate and display a mirror view of the visual data at the head mounted display, and wherein the visual data is at least one of video or image. The device further comprises a power source in communication with the head-mounted display, the processor module and the camera. In one embodiment, the power source is a battery. In another embodiment, the power source comprises solar panels to supply electrical power.

Another aspect of the present disclosure is directed to a rearview capturing device, comprising: a camera configured to capture visual data of rearward field of view of a user; a processor in communication with the camera configured to generate and display a mirror view of the visual data at a display device, wherein the visual data is at least one of video or image, and wherein the camera is a wearable camera comprising a display and a power source; and a power source in communication with the camera, the display screen and the processor. In one embodiment, the camera is configured to record visual data.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1 exemplarily illustrates a smart glass mounted with a rearview capturing device, according to an embodiment of the present invention;

FIG. 2 exemplarily illustrates a camera mounted at a rear end of a right arm of the smart glass, according to an embodiment of the present invention;

FIG. 3 exemplarily illustrates the smart glass having an extend arm mounted with the camera, according to an embodiment of the present invention;

FIG. 4 exemplarily illustrates a smart frame mounted with the rearview camera, according to an embodiment of the present invention;

FIG. 5 exemplarily illustrates the camera mounted at a rear side of a cap, according to an embodiment of the present invention;

FIG. 6 exemplarily illustrates the camera mounted at a rear side of a helmet, according to an embodiment of the present invention;

FIG. 7 exemplarily illustrates the camera mounted at a rear side of a user's garment, according to an embodiment of the present invention;

FIG. 8 exemplarily illustrates the camera mounted at a rear arm portion of the user's garment, according to an embodiment of the present invention;

FIG. 9 exemplarily illustrates an officer equipped with the rearview camera on his right shoulder or epaulet, according to an embodiment of the present invention;

FIG. 10 exemplarily illustrates a rear side of the officer equipped with the rearview camera on his right shoulder or epaulet, according to an embodiment of the present invention;

FIG. 11 exemplarily illustrates the rearview camera mounted at a strap of a handbag, according to an embodiment of the present invention;

FIG. 12 exemplarily illustrates a user monitoring a rearward field of view using a smartphone, according to an embodiment of the present invention; and

FIG. 13 exemplarily illustrates a user monitoring a rearward field of view using a smart eyewear, according to an embodiment of the present invention.

FIG. 14 exemplarily illustrates a wearable rearview capturing device, according to another embodiment of the present invention.

FIG. 15 exemplarily illustrates a smart glass with a rearview camera which has been inserted into the rear-end of its arm, according to another embodiment of the present invention.

### DETAILED DESCRIPTION

The present invention generally relates to a rearview capturing device and more particularly relates to a wearable rearview capturing device configured to display a field of view of the region behind a user without interfering the user's forward and peripheral vision.

A description of embodiments of the present invention will now be given with reference to the figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

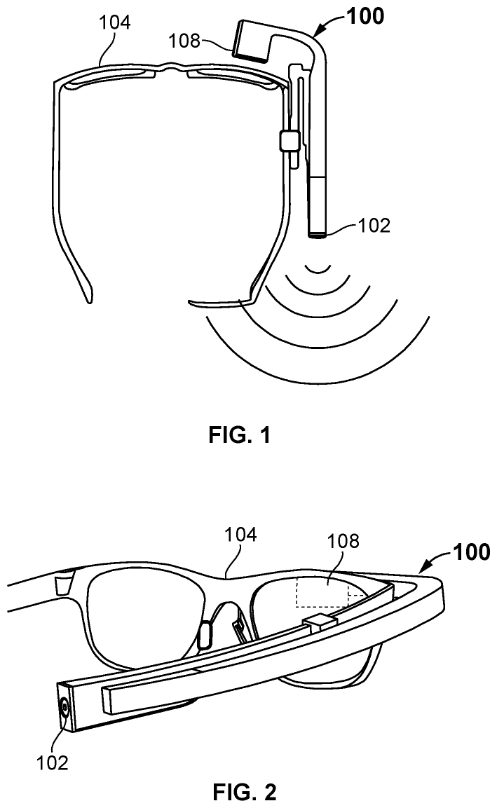

Referring to FIG. 1, the present invention discloses a wearable rearview capturing device 100. The device 100 is configured to display a field of view of the region behind a wearer/user without interfering the forward and peripheral vision. The device 100 is configured to display a field of view of the region behind a user. The device 100 comprises a camera or rearview camera 102, shown in FIG. 2, and a processor in communication with the camera 102. The camera 102 is configured to capture visual data of rearward field of view of the user. The processor in communication with the camera 102 is configured to generate a mirror view of the visual data. The device 100 further comprises a display device in communication with the processor to display the mirror view of the visual data.

In one embodiment, the display device is a display screen 108. In one embodiment, the visual data is at least one of video or image. The mirror view of the visual data is configured to display objects located in left and right side behind the user's head, respectively, from the user's point of view. This enables an object located in left back side of the user would be seen on left in front of the eyes on the screen, and the same for the right side; as the images seen in the mirror. The mirror view of visual data displays video or images similar to the image's/videos seen using the selfie camera of smartphone, before taking the picture, because once the button is pushed, it reverses the image once again. In one embodiment, the camera 102 and processor are paired and synced with the display device using a software application via at least one of a wired component or a wireless component. In another embodiment, the camera 102 is synced and connected to the processor via at least one of a wired or wireless module.

Referring to FIG. 1 to FIG. 6, in another embodiment, the device 100 comprises a head mounted smart glass/smart glass 104/head mounted display 108 comprising a processor module and the camera 102 in communication with the processor module. The processor module is configured to generate the mirror view of the visual data. The device 100 to display the mirror view of the visual data at the head mounted smart glass 104. In one embodiment, the smart glass 104 is defined to be a smart glass due to the incorporation of device 100 in the normal eyewear or glasses. In one embodiment, the head mounted display 108 is paired and synced with the camera 102 using a software application via at least one of wired component or wireless component. In one embodiment, the wireless component could utilize at least one network technology, including, but not limited to, WiMAX, Bluetooth®, and probable technologies that will not be having any negative impact to the brain.

In yet another embodiment, the device 100 comprises the camera 102, the processor in communication with the camera 102 and the display screen in communication with the processor. The camera 102 is configured to capture the image and/or video of the rearward field of view of the user. The processor is configured to generate the mirror image and/or mirror video of the captured image/or video. The display screen in communication with the processor is configured to display the generated mirror image and/or mirror video to the user.

In one embodiment, the smart glass 104 is selected from a group, including, but not limited to, Google Glass™, Intel's Vaunt Smart Glass, North's Focals, Microsoft Holographic Lens™, Amazon backed Smart Glass and the smart glass that is expected to be launched soon by Apple. In another embodiment, the smart glass 104 is selected from a group, including, but not limited to, an augmented reality glass, a mixed reality glass, a virtual reality glass and a smart glass that may be developed to function as a smart phone, or any other functionalities.

In one embodiment, the mirror view of visual data is displayed at the smart glass 104. In another embodiment, the mirror view of visual data is displayed in at least one lens of the smart glass 104. In yet another embodiment, the mirror view of visual data is displayed in both lens of the smart glass 104. In yet another embodiment, the mirror view of visual data is displayed at a part of the lens of the smart glass 104, to enable the user to see both front and rear field of view at a time.

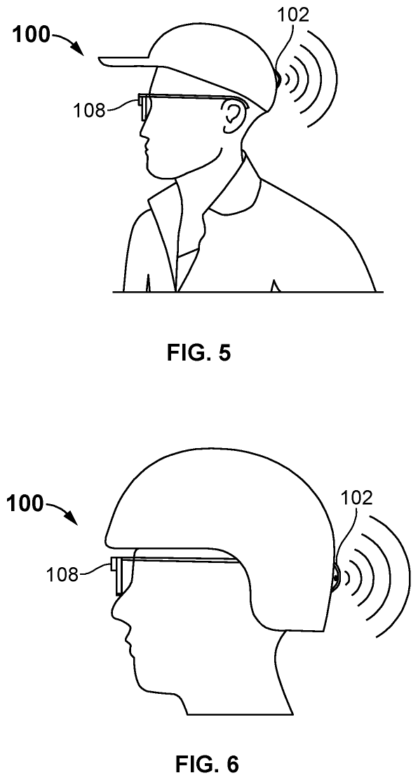

Referring to FIG. 5, in yet another embodiment, a combination of camera 102 mounted on the back of a cap and a smart glass 104 to show the provided images. In yet another embodiment, the mirror view of visual data is directly projected onto the user's retina. In yet another embodiment, the mirror view of the visual data is directly projected onto the user's retina by laser. This enables the user to see rearward field of view in real time, constantly at any time. In one embodiment, the camera 102 is connected to a processor module and a power source of the smart glass 104 for processing the visual data of the camera 102.

The processor module is configured to reverse the visual data to generate the mirror view of the visual data. In one embodiment, the processor module is configured to reverse the visual data using one or more program instructions stored in a memory. In one embodiment, the processor module is configured to reverse the visual data using photo editing software such as photoshop or less advanced applications like the ones used in all smart phones equipped with the selfie camera while using it before just taking the selfie photo. After taking the selfie photo once again the image is reversed to reflect it as it is from the smart phone point of view and not from the user point of view. In one embodiment, the rearview capturing device 100 further comprises a power source to supply power to the components of the device 100, including, but not limited to, the display device, the camera 102 and the processor. In one embodiment, the processor is an a/m processor. In one embodiment, the power source is a battery. In another embodiment, the power source comprises solar panels to supply electrical power.

In another embodiment, the camera 102 is also configured to record audio data. In one embodiment, a position of the camera 102 is adjustable to provide a proper rearview for the user. In another embodiment, the position of the camera 102 is non-adjustable to provide a proper rearview for the user. In one embodiment, resolution and size, field of view of the camera 102 could vary based on the need of the end-user or based on the manufacturer's preferences. In another embodiment, the field of view of the camera 102 could be 135 degrees wide, horizontally, similar to the eyes or even narrower. In another embodiment, the size of the camera 102 is similar to size of smartphone camera. In yet another embodiment, the size of the camera 102 is tiny and similar to size of the spy camera. In one embodiment, the smart glass 104 is at least one of prescribed eyewear, sunglass, decorative eyewear, professional eyewear, protective eyewear or goggles such as ski goggles.

In one embodiment, the display device is a display screen embedded in at least one of smart glasses, bionic lens, contact lens, or spectacles. In yet another embodiment, the display device is a display screen embedded in a windshield of vehicle such as motorcycle, bike. In one embodiment, the display screen is used partially, or totally to display mirror image or video obtained from the rearview camera 102. In one embodiment, the display screen is used partially, or totally to display mirror image or video based on the preferences of the end user or the manufacturer. In one embodiment, the camera 102 is at least one of a colored camera, a black and white camera, a monochrome camera, a night vision camera, or an infrared camera.

Referring to FIG. 1, a rearview capturing device 100 mounted on a smart glass 104. Particularly, 100 is the component that makes the glass 104 a smart glass. Without it, 104 looks and works as an ordinary glass. At the rear end of the device 100, a backward camera is added in this invention to provide the intended function of the present invention. The rearview capturing device 100 is mounted to a right arm of the smart glass 104. In another embodiment, the camera 102 is mounted at the right arm of the smart glass 104. In another embodiment, the camera 102 is mounted at the left arm of the smart glass 104. In yet another embodiment, the camera 102 is mounted at both the right and left arm of the smart glass 104. In yet another embodiment, the camera 102 is mounted to the smart glass 104 via a jack to either arms or frame of the smart glass 104.

The display screen 108 is disposed at the smart glass 104. In one embodiment, the rearview capturing device 100 is attached to a left arm of the smart glass 104. Referring to FIG. 2, the camera 102 is inserted into the rear end of the right arm of the smart glass 104. In one embodiment, the camera 102 is inserted into the rear end of the left arm of the smart glass 104. In one embodiment, the camera 102 is inserted into both rear ends of the right arm and left arm of the smart glass 104. The display device is embedded within the lens of the smart glass 104 (see FIG. 15). In one embodiment, the display device is a see-through screen embedded in at least one lens of the smart glass 104. In another embodiment, the display device is a see-through screen embedded in both lenses of the smart glass 104 (see FIG. 15).

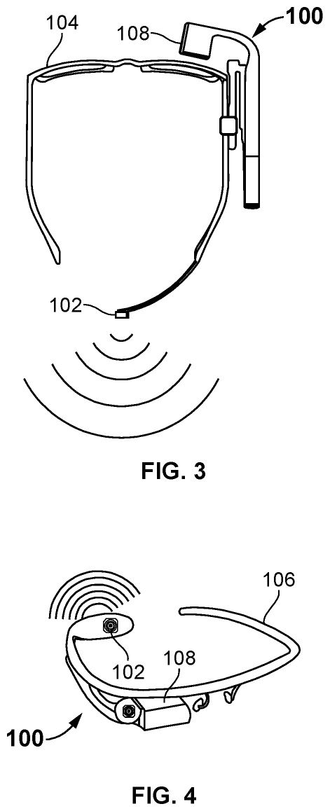

In one embodiment, the display device is a see-through screen. In another embodiment, the display 108 is a screen added to the glass in FIG. 1-FIG. 4. In another embodiment, the display device is at least one of a smartphone, a computer, a smartwatch, a tablet or an electronic device with a display. Referring to FIG. 3, the smart glass 104 comprises an extended arm. The camera 102 is mounted at the extended arm to prevent long hair, head coverings, apparel worn by the user or other items obstructing the camera 102 from obtaining the visual data.

Referring to FIG. 4, the camera 102 is mounted an arm extending from the smart frame 106. In another embodiment, the camera 102 is mounted on one of the right or left arms or both arms of the smart frame 106. The display screen 108 is mounted in front of the area of frame 106 at a right eye of the user. In one embodiment, the display screen 108 is mounted in front of the left eye. In another embodiment, the display screen 108 is mounted in front of the area of frame 106 at both right eye and left eye of the user. In one embodiment, the smart frame 106 could be mounted over regular eyewear or it could be used solely. Referring to FIG. 5, the camera 102 is attached at a rear side of a cap. The camera 102 mounted at the cap captures visual data of a region behind the user and transmits to a processor module of the smart glass 104. The processor is configured to generate a mirror view of the visual data and displays the mirror view of the visual data to the user at the smart glass 104. In one embodiment, the camera 102 could be mounted on at least one of a top portion, a bottom portion or side portions of the cap or any other types of hats or head-coverings like turbans.

Referring to FIG. 6, the camera 102 is attached at a rear side of a helmet. The camera 102 mounted at the helmet captures visual data of a region behind the user and transmits to a processor module of the smart glass 104. The processor is configured to generate a mirror view of the visual data and displays the mirror view of the visual data to the user at the smart glass 104. In one embodiment, the camera 102 could be mounted on at least one of a top portion, a bottom portion or side portions of the helmet.

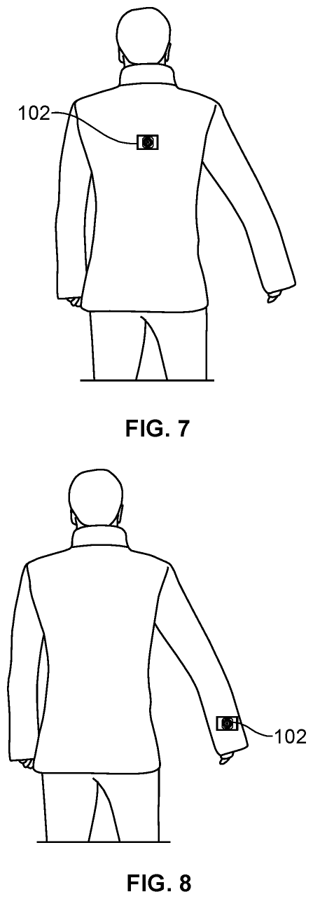

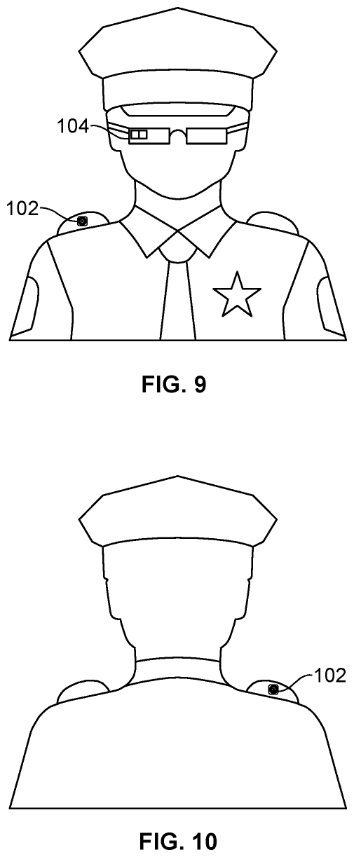

In one embodiment, the camera 102 is attached to a rear side of the user's garment, as shown FIG. 7. In another embodiment, the camera 102 is attached to a rear side of garment on the user's arm region, as shown in FIG. 8. In one embodiment, the rearview camera 102 could be mounted on at least one of a top portion, a bottom portion or side portions of the garment. In yet another embodiment, the rearview camera 102 is attached to a user's epaulet or on user's shoulder facing backward, as shown in FIG. 9. A rearview of the camera 102 attached to the user's epaulet is shown in FIG. 10. These rearview images provided by the a/m rearview camera, could be viewed on the screen of the smart glass, smartphone, smartwatch, tablet or any other device equipped with a screen and connection capability.

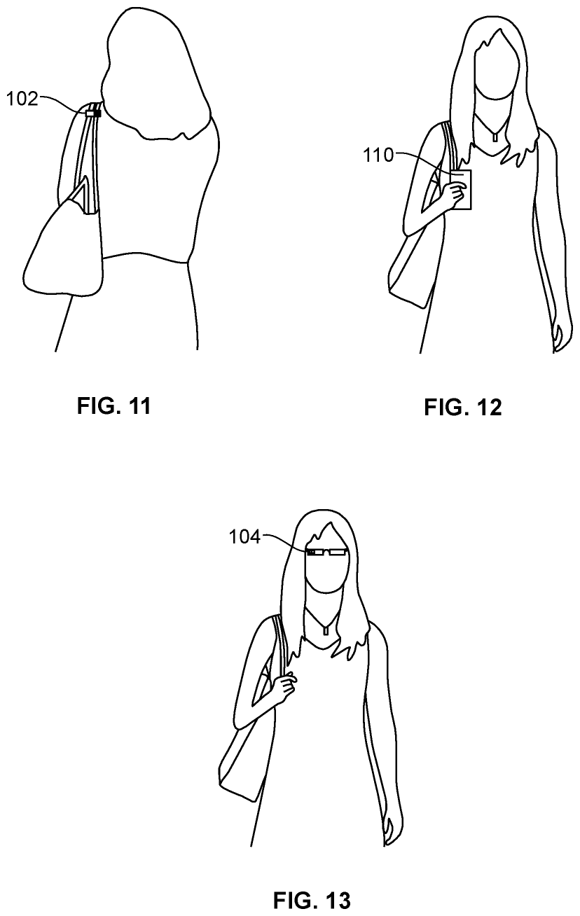

In yet another embodiment, the rearview camera 102 is attached to a strap of a handbag, shown in FIG. 11. In yet another embodiment, the camera 102 is attached to any type of bag, or to a strap of any type of bag. In yet another embodiment, the camera 102 could be mounted on body or strap or any other part of backpack or purse. In yet another embodiment, the camera 102 could be mounted on any desired region of any article. In yet another embodiment, the camera 102 could be removably mounted to any article/items. In yet another embodiment, the camera 102 could be fixedly mounted to any article/items. FIG. 12 exemplarily illustrates the user monitoring a rearward field of view using a smartphone 110, according to an embodiment of the present invention. FIG. 13 exemplarily illustrates the user monitoring the rearward field of view using the smart glass 104 according to an embodiment of the present invention.

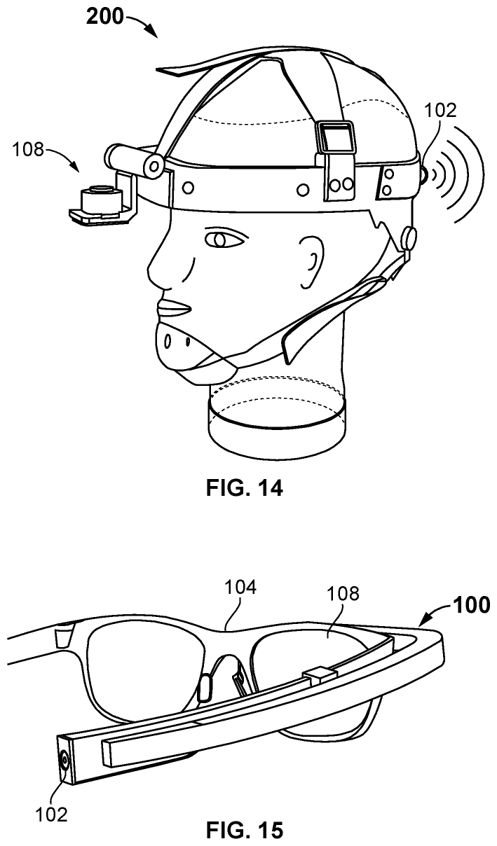

FIG. 12 and FIG. 13, each in combination with FIG. 11 show different types of seeing rearward view exemplarily. The smart glass 104 displays the rearview image obtained by the rearview camera 102 on the strap of her bag, as shown in FIG. 11, or the rear-view camera 102 attached to the rear side of her outfits or accessories. FIG. 14 exemplarily illustrates a wearable rearview capturing device 200, according to another embodiment of the present invention. The wearable rearview capturing device 200 comprises the display screen 108, and the rearview camera 102.

Referring to FIG. 15, in yet another embodiment, the mirror view of visual data is displayed at the display screen 108 mounted in front of the area of frame at a left or right eye of the user. In yet another embodiment, a see-through screen is embedded within at least one or both lens of the smart glass 104 to display the mirror view of the visual data.

The ability of providing rearview is tangible for most people because it increases their security and provide a secure feel to the user. This safety measure would interest many customers and in return increases the sales of smart glass 104. As a result, the price per piece of the smart glass 104 would be decreased, which again makes it more affordable for a larger group of people. Since this function does not require complex engineering and a very complicated and expensive processor and screen, the price of the device 100 will be so low that it could be accessible to many potential users. In this case, it will be consisted of simple components that make the final price low and easily affordable to many. Otherwise, smart glasses providing other functions rather than rearward view are consisted of components which are relatively expensive but as described above by higher sales the final price will drop. In case, a smart glass or other possible embodiments of this invention are intended to be made; otherwise, this function of rearview can be added to other devices as described earlier as an additional feature which are logically much more expensive.

Further, providing rearview for users prevents many robberies, accidents, death and murders. In addition, by lowering the anxiety of its users it will play a role in lowering Hypertension, Cardiovascular Diseases and other stress related disorders. The device 100 enables the users to have a constant rearview, or enables the user to use rearview at any desired time without raising the sensitivities, which in return lowers the anxiety created by being unaware of surroundings.

The present invention would increase the security of users by giving them the ability to see backward in real-time manner without the need to turn their heads, which may be provocative in some occasions and would deprive them from seeing the other side while the head is turned back. The device 100 could be used by individual, including, but not limited to, bodyguards, security forces, law-enforcement personnel, police officers and soldiers in the first place because it dramatically increases their security and their visual awareness of their surroundings. However, ordinary people would also utilize the device 100 to increase the awareness about their surroundings while sitting, standing or walking on pavements and streets, in parks, jungles, public places and in nature which enables them to react in time to animals, robbers, attackers, bikes, motorcycles, vehicles, trucks and any kind of moving objects.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions.

Although specific terms may be employed herein, they are used only in generic and descriptive sense and not for purposes of limitation. Accordingly, the present invention is not limited to the specific embodiments illustrated herein. While the above is a complete description of the preferred embodiments of the invention, various alternatives, modifications, and equivalents may be used. Therefore, the above description and the examples should not be taken as limiting the scope of the invention, which is defined by the appended claims.

1-21. (canceled)

22. A rearview capturing device, comprising: a camera facing rearward attached to at least one of rear end, a side end, a top end or a bottom end of an article of clothing worn or a bag carried by the user, wherein the camera is configured to capture, display and record real-time visual data of rearward field of view of a user,
a control unit including a processor in communication with the rearview camera and a display screen, via at least one of a wired module or a wireless module, the processor configured to generate and display a mirror view of the visual data by reversing the captured images from the rearview camera,
at a display screen either on an eyewear worn by the user or on an external terminal display screen,
wherein the visual data is at least one of video or image,
and wherein the device comprises a wearable/portable rearview camera, a display screen, a control unit including a processor and
a power supply in communication with the camera, the display screen and the control unit wherein the power supply is one of a battery, batteries or solar panels.

23. The device of claim 22, wherein the wireless module between the rearward camera and the processor and also between the processor and the display screen is one of the Bluetooth®, Near Field Communication (NFC), Radiofrequency Identification (RFID), Infra-red (IR) communication, 5G, Mobile Communication, Wireless Internet, WiFi, WiMax, or any other wireless technology

24. The device of claim 22, wherein the display screen on an eyewear is a bionic contact lens.

25. The device of claim 22, wherein the external terminal display screen is a smartwatch.

26. The device of claim 22, wherein the camera is detachably mounted at an article worn or an item carried by the user.

27. The device of claim 22, wherein the camera is adjustably mounted at an article worn or a bag carried by the user. The adjustment might be done manually or automatically by the processor using gyro sensors and acceleration sensors, and such.

28. The device of claim 22, wherein the processor module is configured to generate and display the mirror view of the visual data, by reversing the images captured by the rearview camera, at the display screen.

29. The device of claim 22, wherein the camera is at least one of a colored camera, a black and white (gray scale) camera, a monochrome camera, a night vision camera, or an infrared camera.

30. The device of claim 22, wherein the device might be additionally configured to record audio data along with the visual data.

31. The device of claim 22, wherein the visual data is displayed in at least a portion of the display screen.
